(19) United States
(12) Patent Application Publication
(10) Pub. No.: US 2009/0049190 A1
(43) Pub. Date: Feb. 19, 2009

(54) MULTIPLE POINTS OF PRESENCE IN REAL TIME COMMUNICATIONS

(75) Inventors: Linlong Jiang, Sunnyvale, CA (US); Alan Li, San Jose, CA (US); Raj Vemulapalli, San Jose, CA (US); Manish Godara, Fremont, CA (US); Ming J. Lu, Saratoga, CA (US)

Correspondence Address: MPG, LLP AND YAHOO! INC., 710 LAKEWAY DRIVE, SUITE 200, SUNNYVALE, CA, 94085, US

(73) Assignee: YAHOO!, INC., SUNNYVALE, CA (US)

(21) Appl. No.: 11/840,184

(22) Filed: Aug. 16, 2007

(51) Int. Cl. G06F 15/173

(52) U.S. Cl. 709/238

(57) ABSTRACT

Systems and methods are provided for multiple points of presence (MPOP) in the real time communication of data between or among users. More particularly, according to embodiments of the present invention, a messaging service network is provided that allows a user to connect to the messaging service network from multiple client devices and access features associated with the messaging service network from any one of the multiple client devices at any point in time. In this manner, a user can seamlessly transition among multiple client devices without interruption and access services provided by the messaging service network including, but not limited to, sending/receiving instant message (or “IM”) data to other user(s), publishing/subscribing presence to other user(s), making/receiving phone calls between user(s), etc.

### FIELD OF THE INVENTION

The invention relates generally to real-time communication and, more particularly, to providing multiple points of presence during real-time communication.

### BACKGROUND

### Description of the Related Art

Instant messaging (or IM) is one form of real-time communication between two users. Conventionally, IM is based on text typed by two or more users where the text is conveyed from one user to another user via computers connected over a messenger network such as the Internet. In general, instant messaging requires the use of a client application that can access an instant messaging service (e.g. NET Messenger Service™, AOL Instant Messenger™, Google Talk™, iChat™, ICQ, Meetro™, Trillian™, MSN Messenger™, Window Live Messenger™, Excite/Pal™, Gadu-Gadu™, Jabber™, Qnext™, QQ™, Rediff Bol Instant Messenger™, SKype™, etc.) located on another computer via the messenger network. The messaging service facilitates real-time conversations between or among users via the messenger network. The messaging service can also provide a presence feature that indicates whether people who are included on a user's list of contacts are currently online and available to communicate.

Unfortunately, if a user is currently signed into a conventional messenger service at one client computer, and the user signs into the messenger service from a different client computer the connection the user established with the messenger service from the one client computer will be disconnected. This undesired result applies across all types of communication channels (e.g. desktop, Web, mobile, etc.) and occurs because conventional messaging services or platforms support only a single point of presence (SPOP). SPOP means that the messenger service only allows a user to maintain one connection to a messenger network at any one time. For example, a user is signed into a messaging service using a desktop client computer located at the user's home. If the user later signs into the messaging service from a personal data assistant (PDA) or another client computer at another location without signing off the desktop client computer, the home connection will be automatically disconnected or the user will be forced to sign off the home connection before the PDA connection can be established.

Some messaging services like AOL Instant Messenger™ and SKype™ attempt to overcome the undesired effects of SPOP by allowing a user to maintain more than one connection to a messenger network at the same time. However, these messaging services do not maintain the multiple connections in a manner that allows the user to move seamlessly from one client computer to another without interruption.

In view of the forgoing, there is a need to provide, among other things, a user with the capability to simultaneously maintain more than one connection to a messenger network in a manner that allows the user to move seamlessly from one client computer to another with interruption.

### SUMMARY

In one embodiment, the present invention provides a system for providing multiple points of presence in real time communications. The system comprises a messaging service network, where the messaging service network includes a server and the server is capable of managing real time delivery of data between a first user and a second user. The system also comprises two or more client devices associated with the first user, where each of the two or more client devices is programmed to establish a connection to the server. To allow the first user a capability to transition among each of the two or more client devices without interruption, the server is configured to simultaneously maintain each connection and selectively deliver the data to the two or more client devices via the connections based on a type of the data and a capability of each of the two or more client devices.

In another embodiment, the present invention provides a system for providing multiple points of presence in real time communications. The system comprises a messaging service network, the messaging service network includes a server, where the server is capable of managing real time delivery of data between a first user and a second user, where the data is utilized to establish a session between the first user and the second user. The system also comprise a client device associated with the first user, where the client device associated with the first user is programmed to establish a first connection to the server, and where the client device associated with the first user is a location where the first user is currently active. The system further comprises two or more client devices associated with the second user, where each of the two or more client devices is programmed to establish a second connection to the server, and where one of the two or more client devices associated with the second user is a location where the second user is currently active. To allow the second user a capability to transition among each of the two or more client devices without interruption, the server is configured to simultaneously maintain each second connection and selectively deliver the data to the two or more client devices via the second connections based on a type of the data and a capability of each of the two or more client devices. The session is utilized to provide the real time delivery of session-based data between the client device associated with the first user and the one of the two or more client devices associated with the second user.

In yet another embodiment, the present invention provides a system for providing multiple points of presence in real time communications. The system comprises a messaging service network, where the messaging service network includes a server, the server is capable of managing real time delivery of data between a first user and a second user, and the data is utilized to establish a media stream between the first user and the second user. The system also comprises a client device associated with the first user, where the client device associated with the first user is programmed to establish a first connection to the server and the client device associated with the first user is a location where the first user is currently active. The system further comprises two or more client devices associated with the second user, where each of the two or more client devices is programmed to establish a second connection to the server, and one of the two or more client devices associated with the second user is a location where the second user is currently active. To allow the second user a capability to transition among each of the two or more client devices without interruption, the server is configured to simultaneously maintain each second connection and selectively deliver the data to the two or more client devices via the second connections based on a type of the data and a capability of each of the two or more client devices. The media stream is utilized to provide the real time delivery of voice data between the client device associated with the first user and the one of the two or more client devices associated with the second user.

Other aspects and advantages of the invention will become apparent from the following detailed description, taken in conjunction with the embodiments and accompanying drawings, illustrating, by way of example, the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration of a system for providing multiple points of presence in the real time communication of data between or among multiple users, in accordance with an embodiment of the present invention;

FIG. 2A is an illustration of a method for sending instant message (IM) data from one user to another user, in accordance with an embodiment of the present invention;

FIG. 2B is an illustration of a method for replying to the instant message (IM) data sent in FIG. 2A, in accordance with an embodiment of the present invention;

FIG. 3 is an illustration of a method for processing a “close window” command message, in accordance with an embodiment of the present invention;

FIG. 4A is an illustration of a method for processing an “add buddy” command message, in accordance with an embodiment of the present invention;

FIG. 4B is an illustration of a method for sending an “authorize buddy add” command message, in accordance with an embodiment of the present invention;

FIG. 4C is an illustration of a method for processing an “add buddy failure” command message, in accordance with an embodiment of the present invention;

FIG. 5 is an illustration of a method for processing an “update stealth setting” command message, in accordance with an embodiment of the present invention;

FIG. 6 is an illustration of a method for processing a “status change” command message, in accordance with an embodiment of the present invention;

FIG. 7A, is an illustration of a method for processing an “invite” command message for session-based communication, in accordance with an embodiment of the present invention;

FIG. 7B, is an illustration of a method for processing an “accept invite” command message in response to the “invite command” message sent in FIG. 7A, in accordance with an embodiment of the present invention;

FIG. 7C is an illustration of a system for providing session-based real time data communication between users, in accordance with an embodiment of the present invention;

FIG. 8 is an illustration of a system and method for providing voice data communication between users, in accordance with an embodiment of the present invention; and

FIG. 9 is an illustration of a method for providing alert data to all client devices associated with a particular user, in accordance with an embodiment of the present invention.

### DETAILED DESCRIPTION

Embodiments of the present invention provide systems and methods for providing multiple points of presence (MPOP) in the real time communication of data between or among users. More particularly, according to embodiments of the present invention, a messaging service network is provided that allows a user to connect to the messaging service network from multiple client devices and access features associated with the messaging service network from any one of the multiple client devices at any point in time.

In this manner, a user can seamlessly transition among multiple client devices without interruption and access services provided by the messaging service network including, but not limited to, sending/receiving instant message (or “IM”) data to other user(s), publishing/subscribing presence to other user(s), making/receiving phone calls between user(s), etc. The messaging service network of embodiments of the present invention can maintain each one of the multiple client devices as instances of a particular user.

The messaging service network can selectively deliver data among the client devices associated with a particular user or between client devices associated with different users based on whether the data is suitable for delivery on connection(s) associated with particular a client device; whether the data is compatible with the features or capabilities of the client device; whether a particular client device is the device where a user is currently active (e.g. physically located, or user has designated as active); and/or whether user delivery preferences are associated with a connection or a client device.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention. The present invention includes several aspects and is presented below and discussed in connection with the Figures and embodiments.

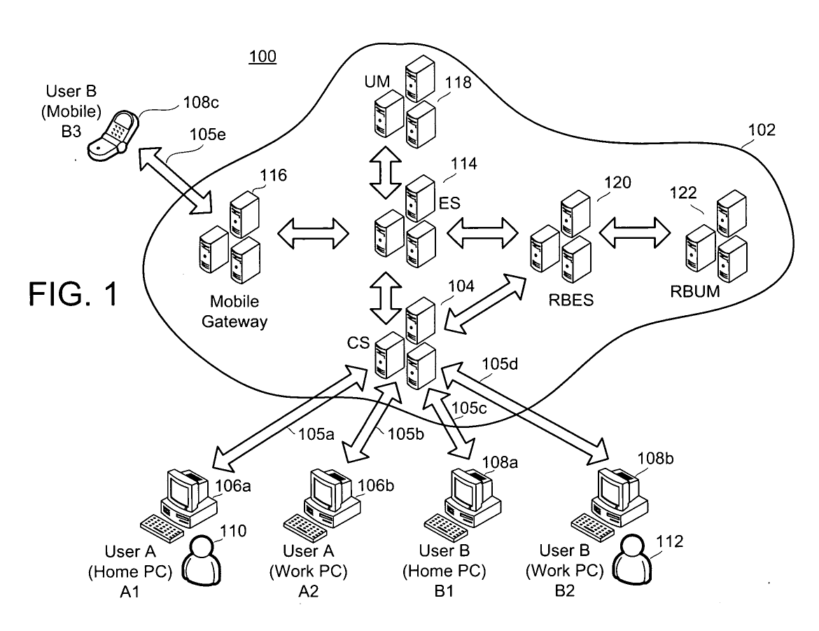

In FIG. 1, according one embodiment of the present invention, is an illustration of a system 100 for providing multiple points of presence in the real time communication of data between or among multiple users 110, 112, e.g. “User A” 110 and “User B” 112. In one embodiment of the present invention, the system 100 includes a messaging service network 102 that is capable of managing the real time delivery of data between or among multiple users and providing services including, but not limited to, sending/receiving instant message or instant message (or “IM”) data, publishing/subscribing presence, transferring files, photo sharing, receiving alerts, or making/receiving phone calls, or any other service relevant to the real time communication of data. It is important to note that one skilled in the relevant art will recognize that the messaging service network 102 can be implemented with or without one or more of the specific details or components discussed below.

In one embodiment, the messaging service network 102 can include at least one connection server (CS) 104. In one embodiment, CS 104 is a server that maintains connections 105a-105d (e.g. socket connections) established with messaging service network 102 from most client devices 106a-106b, 108a-108b except mobile client devices 105e. The connection 105e between mobile client device 108c and mobile gateway server 116 can be thru a mobile carrier gateway and mobile servers that utilize protocols such as HTTP, TCP, and other proprietary protocols.

In one embodiment, CS 104 can be coupled to one or more non-mobile client devices 106a, 106b that are associated with a User A 110. CS 104 can also be coupled to one or more non-mobile client devices 108a, 108b associated with a different User B 112. In one embodiment of the present invention, client devices 106a-106b, 108a-108c can include, but are not limited to, a mobile device, a laptop computing device, a desktop computing device, a personal data assistant or “PDA,” a notebook, a microcomputer, a server, a personal data manager or “PIM” (also referred to as a personal information manager or “PIM”), a web-based client, a smart mobile device or any other mobile device including, for example, an IP phone or an iPhone™.

In one embodiment of the present invention, the messaging service network 102 can also include at least one event server (ES) 114, coupled to CS 104. ES 114 can host the application logic layer of messaging services network 102. In one embodiment of the present invention, messaging service network 102 can further include at least one mobile gateway server 116 coupled to ES 114. ES 114 can be capable of providing connectivity between a mobile device 108c and messaging service network 102. Mobile devices can communicate with the messaging service network 102 through HTTP or a TCP connection (and the like), and employ polling or pushing mechanisms to retrieve or deliver messages.

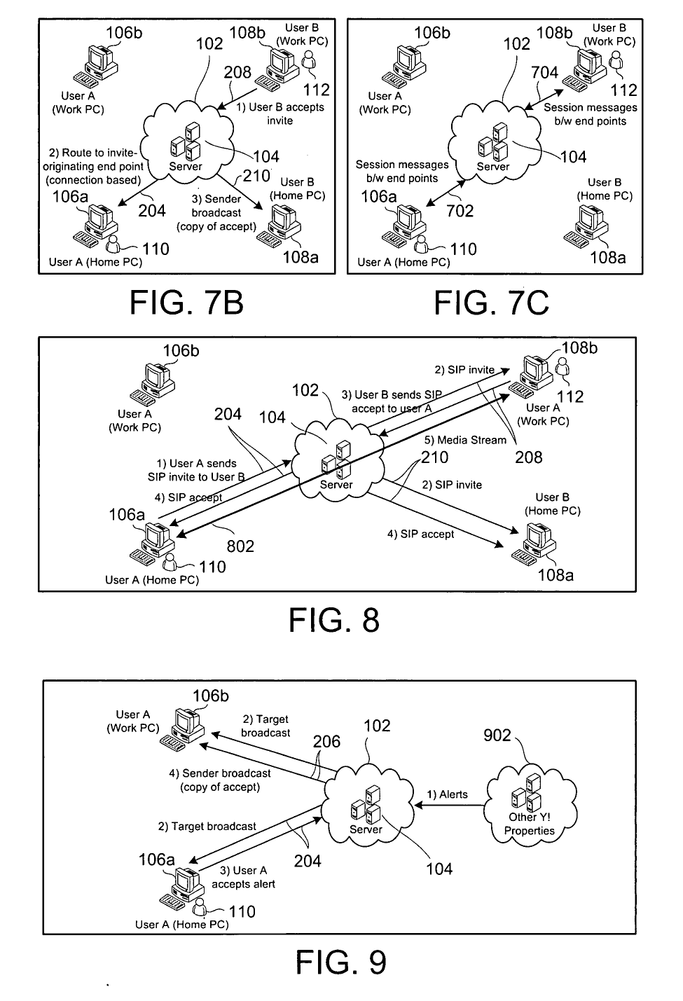

In one embodiment, messaging service network 102 can also include at least one user manager server (UM) 118 coupled to ES 114. UM 118 can be a cache server or any other server suitable for maintaining user sessions between users 110, 112 for the communication of session-based data (e.g. file transfer data, photo sharing data, web cam data, etc.), as discussed in more detail below FIGS. 7A-7C. Messaging server network 102 can also include at least one reverse buddy event server (RBES) 120 coupled to CS 104 and further coupled to ES 114 and at least one reverse buddy user manager server (RBUM) 122, according to one embodiment of the present invention. In one embodiment, RBES 120 can be any server suitable for handling status notifications sent among client devices 106a-106b, 108a-108c associated with a particular user 110, 112 or sent to client devices 106a-106b, 108a-108c associated with one or more different users, as discussed in more detail below in FIG. 6. In one embodiment, RBUM 122 can be a cache server or any other server that can be used by RBES 120 for handling the status notifications.

Referring still to FIG. 1, according to one embodiment of the present invention, system 100 can provide a user 110,112 with the ability to login to messaging service network 102 from multiple client devices 106,108 at the same time thereby facilitating user access to services (e.g. instant messaging, voice messaging, mobile messaging, etc.) provided by the messaging service network 102 from several locations at the same time. More particularly, in one embodiment of the present invention, each non-mobile client device 106a, 106b, 108a, 108b can be programmed to establish a corresponding socket connection 105a-105d to messaging service network 102 when the user 110,112 associated with the non-mobile client device 106a, 106b, 108a, 108b logs into or connects to messaging service network 102 from client device 106a, 106b, 108a, 108b. Likewise, in one embodiment of the present invention, each mobile client device 108c can be programmed to establish a corresponding connection 105e, such as an HTTP or a TCP connection with polling or pushing mechanism, to messaging service network 102 when the user 110,112 associated with the mobile client device 108c logs into or connects to messaging service network 102.

It is important to note that according to embodiments of the present invention, connections 105a-105d and connections 105e can be any type of connection suitable for the delivery of data between a client device 106a-106b and a client device 108a-108c, among client devices 106a-106b, among client devices 108a-108c, or between messaging service network 102 and a client device 106a-106b or a client device 108a-108c.

In one embodiment of the present invention, messaging service network 102 can simultaneously manage each connection 105a-105d,105e and the data delivered on the connection 105a-105d,105e to allow a users 110,112 the capability to seamlessly transition to any one of client devices 106a-106b,108a-108c associated with the user 110,112 without interruption. For example, in one embodiment of the present invention, the management of each connection 105a-105e by messaging service network 102 can include determining the delivery of data on each connection 105a-105e based on, among other things, which one of the client devices 106a-106b, 108a-108c associated with a particular user 110,112 is the client device 106a-106b, 108a-108c where the user 110,112 is currently active; a delivery preference associated with a connection 105; the type of data being delivered on a connection 105a-105e; and/or a capability or feature associated with a particular client device 106a-106b, 108a-108c. Specifically, in one embodiment of the present invention, messaging service network 102 can manage different routing modes and connection modes to facilitate real time communication of data between users 110, 112 in system 100.

Specifically, according to an embodiment of the present invention, being able to correctly and efficiently route and deliver messages in an MPOP environment is an essential and critical requirement. A server of messaging service network 102, for example CS 104 should be able to determine how and what should be delivered to a user's 110, 112 client device 106a-106b, 108a-108c based on the type of data being delivered and client devices 106a-106b, 108a-108c capabilities. To cover multiple routing scenarios, routing modes can include “target broadcast,” “sender broadcast,” “complete broadcast,” “reply broadcast,” “simple reply,” “connection (end point) based,” according to one embodiment of the present invention.

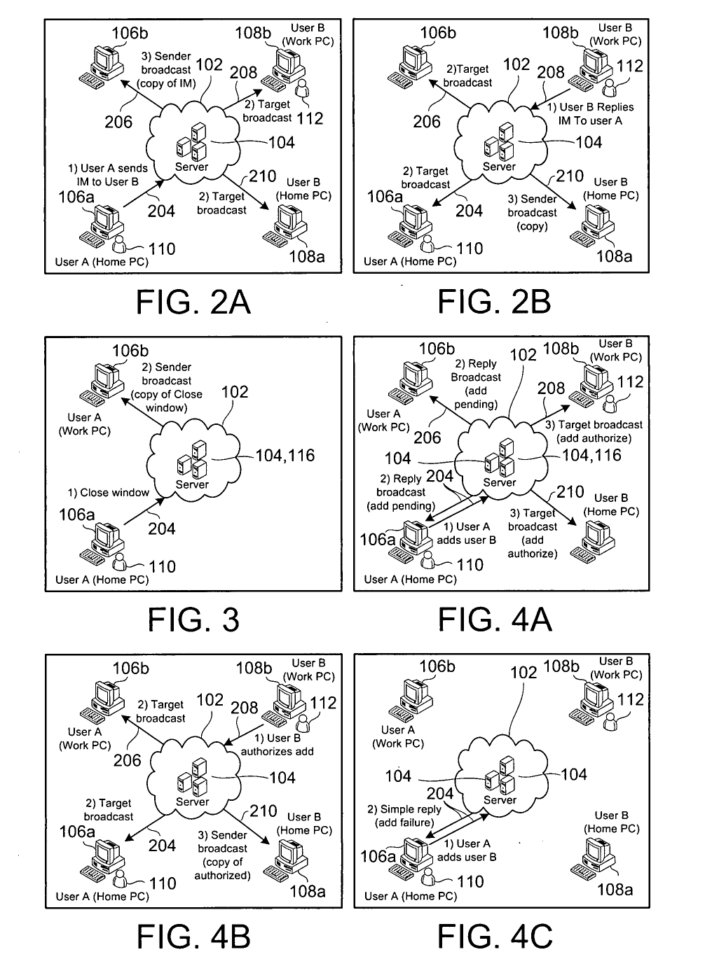

For example, as shown in more detail below in FIGS. 2A-2B, 4A-4B, 5, 6, 7A, and 9, a “target broadcast” can involve sending data from an originating user (i.e. sender) to all instances of client devices associated with a target user (i.e receiver). As shown in more detail below in FIGS. 2A-2B, 3, 4B, 5-6, and 7B, a “sender broadcast” can involve sending a copy of data originally sent from an originating user to a target user to all instances of client devices associated with the originating user, excluding the client device associated with the originating user from which the data was originally sent. In one embodiment of the present invention, a “complete broadcast” is the combination of a “target broadcast” and a sender broadcast.” For example, a complete broadcast involves sending data to all instances of client devices associated with receiver and all instances of client devices associated with sender, excluding the originating client device.

As shown in FIG. 4A, a “reply broadcast” is a modification of a “sender broadcast” in which a copy of the data is sent to all instances associated with an originating user, typically upon successful completion of the command/message (e.g., of a request to the target). In one embodiment, it is used as an acknowledgement reply back to the sender.

Conversely, as shown in FIG. 4C, a “simple reply” can involve sending a copy of the data to the (only) active instance associated with an originating user where the request was originated, typically upon failure. This can happen during any operation, where the server can't process the requests due to some operation error. The server will reply with a “simple reply” to the active client instance and notify it of the operation failure.

In one embodiment of the present invention, “connection (end point) based” message routing involves the sending/receiving of session messages, as illustrated in more detail below in FIG. 7B.

In all of the routing modes discussed above, a client device's 106a-106b, 108a-108c capabilities are taken into consideration. Message data is not sent to a client device 106a-106b, 108a-108c if the client device 106a-106b, 108a-108c is not capable of a specific feature, or not capable of receiving that type of data. For example, in one embodiment of the present invention, mobile client devices 108c are treated specially. Specifically, when a mobile client device 108c is not the device where user 110, 112 is currently active or that user 110 112 has designated active using “Go Mobile,” the mobile device 108c can only receive specific types of command messages, for example, “status change” messages which are described in more detail below in FIG. 6. Consequently, before delivering a message to mobile device 108c on connection 105e, CS 104 can check the mobile device's 108c capabilities and the type of data being delivered to the mobile device (e.g. “status only”). CS 104 can also perform the same type of check for the delivery of message data to non-mobile client devices 106a-106b, 108a-108b, according to embodiments of the present invention.

Referring still to FIG. 1, as mentioned above, messaging service network 102 can also manage different connection modes to facilitate real time communication of data between or among users 110, 112 in system 100. In one embodiment of the present invention, these connection modes can include “primary” connection, “secondary” connection, “status only” connection, and “restricted connection.”

According to one embodiment of the present invention, a “primary connection” is a connection 105a, 105d associated with the current (or last known) location at which user 110, 112 was active. Some actions that can cause a connection 105a-105e to be tagged (or designated) as a primary connection include: the location of client device 106a-106b, 108a-108c where user 110, 112 logged in to messaging service network 102; the location of client device 106a-106b, 108a-108c where user 110, 112 is typing or replying to instant messages (IMs); the location of client device 106a-106b, 108a-108c where user 110, 112 is closing an IM window; the location of client device 106a-106b, 108a-108c from which an explicit status change message (not automatically scheduled status such as calendar-scheduled Busy, or LAUNCHCast songs) originated; the location of client device 106a-106b, 108a-108c user 110, 112 returns to and begins interacting with messaging service network 102; or user 110, 112 performs an action to transfer primary status to another client device 106a-106b, 108a-108c, e.g. user 110, 112 selects “Go Mobile” from a client device (e.g. “User B Work PC”) thereby transferring primary status to mobile device 108c.

According to one embodiment of the present invention, there can be only one “primary connection” 105a, 105d and the primary connection 105a, 105d is owned (or controlled) by the currently active user 110, 112 associated with it. In one embodiment of the present invention, the primary connection 105a, 105d can be utilized to control a user's 110,112 presence status which provides information about whether the user 110,112 is “available,” “busy,” “idle,” “logged in,” or “logged off,” etc. Specifically, the presence status of the primary connection 105a, 105d of a particular user 110,112 can be replicated to all “secondary connections” associated with the same user 110,112 and the presence status of the primary connection 105a, 105d of a particular user 110,112 can be propagated to all other users who has subscribed for the presence of the user 110,112, as discussed in more detail below. In one embodiment of the present invention, a primary connection 105a, 105d has its own capability, preference, and/or plug-in information, as discussed in detail below.

For reference, “plug-ins” are additional modules that can be installed on the messenger clients to provide additional functionality. Such additional modules can be calendars modules, weather modules, stocks quotes modules, etc. All primary plug-in information shall be broadcasted when there is a change or primary state. Still further, each connection may have it's own set of capabilities and plug-ins based on the computer it originated from and the version (functionality) of client software installed on that particular computer.

For example, a capability assigned to a primary connection 105a, 105d can be set based on whether the client device 106a, 108b itself is capable of supporting a particular functionality, e.g. receiving or processing instant message (IM) data. In the same way, a preference assigned to a primary connection 105a, 105d can set based on whether a user 110,112 has a preference for receiving a particular type of data (e.g. instant message (IM) data) at a particular client device 106a-106b,108a-108c.

In one embodiment of the present invention, all non-primary connections are “secondary” connections. In other words, a secondary connection is a connection established with messaging service network 102 from a client device 106a-106b, 108a-108c where a user 110, 112 is not currently active. In one embodiment of the present invention, each secondary connection has its own capability (e.g. “restricted” connection), preference (e.g. “status only” connection, “restricted” connection), and/or plug-in information. In particular, a capability assigned to a secondary connection 105 can be set based on whether the client device 106a-106b, 108a-108c itself or a client application associated with the client device 106a-106b, 108a-108c is capable of supporting a particular functionality, e.g. receiving or processing instant message (IM) data. In the same way, a preference assigned to a secondary connection 105 can set based on whether a user 110,112 has a preference for receiving a particular type of data (e.g. instant message (IM) data) at a particular client device 106a-106b, 108a-108c. For example, a preference assigned to a secondary connection can be set by designating the secondary connection as a “status only” connection. A status only connection is a special type of secondary connection that only receives status notification data and no other type of data. In one embodiment of the present invention, a connection 105e (primary or secondary) established by mobile client device 108c can also be set to a “status only” mode by default when the mobile client device 108c logs into or connects to the messaging service network 102. As previously discussed, because a user's presence status is controlled by a primary connection, each secondary connection associated with the user merely reflects the presence status of the user 110,112. However, in one embodiment of the present invention, a secondary connection can default to a presence status of “available” if the secondary connection is not able to display the primary connection's “rich status”.

For clarity, “simple status” may include only indicating if a user is online and available, or offline. In contrast, “rich status” may indicate additional information, such as a custom status defined by a user. The user may set the status by typing in, for example, “see my webcam” status, “I'm watching a movie” status, “I'm listening to a particular song” status, etc. In the example where the primary connection has a presence status of “see my webcam”, and the secondary connection does not support a webcam, then the client device associated with the secondary connection can simply show a status of “available” instead. In one embodiment, this feature can be manually updated or automatically updated by an application.

In one embodiment of the present invention, the requirements of a particular client application hosted on a particular client device 106a-106b, 108a-108c can be implemented using special type of connection (primary or secondary) called a “restricted” connection. For example, a client application may only be capable of supporting basic functionalities like instant messaging (IM) or status notifications to or from a set of users with whom the client initiated a conversation. In one embodiment, a restricted connection may be limiting either the functionality or limiting the users with which communication is possible, or both. As such, it is possible to limit functionality, and still not consider the connection restricted. When limiting users, a client application may only be capable of sending or receiving data (e.g. IM data) to or from specific user(s), or the client application may only want to send or receive data from specific user(s). Also, a client application may only want a user's presence status to appear as “online” etc. to a selected user(s).

Referring now to FIGS. 2A-9, common use cases and the routing mode and connection mode used in each case are provided for purposes of illustration. It is important to note that one skilled in the relevant art will recognize that the use cases provided are illustrative and, therefore, can be implemented with or without one or more of the specific details or components discussed below.

In FIG. 2A, a method for sending instant message (IM) data from one user 110 (sender) to another user 112 (target) utilizing sender broadcast and target broadcast message routing modes is shown for purposes of illustration. Specifically, at step (1) “User A” 110, who is currently active at client device 106a, sends an instant message to “User B” 112 via messaging service network 102 on primary connection 204. Before delivery of the IM data to “User B,” messaging service network 102 checks the capabilities and/or preferences associated with primary connection 208 and secondary connection 210 to determine whether the data can be delivered to each of the client devices 108a, 108b associated with “User B” 112. At step (2), assuming the IM data can be delivered on both connections 208, 210, messaging service network 102 performs a target broadcast of the IM data on connections 208, 210. In other words, “User B” 112 client device 108b and client device 108a each receive the same IM data message. At step (3), after performing checks on preferences and/or capabilities associated with secondary connection 206, messaging service network 102 performs a sender broadcast of a copy of the IM data on secondary connection 206 to each “User A” 110 client device 106b where “User A” 110 is not currently active. It is important to note that the use of instant message data in FIGS. 2A and 2B (below) is for purposes of illustration only and embodiments of the present invention can be implemented using any type of data suitable for use in the context of real time data communication.

In FIG. 2B, a method for “User B” 112 to reply to the IM data sent by “User A” 110 in FIG. 2A is shown for purposes of illustration. Specifically, at step (1) “User B” 112, who is currently active at client device 108b, sends an instant message reply to “User A” 110 via messaging service network 102 on primary connection 208. Before delivery of the IM data reply to “User A” 110, messaging service network 102 checks the capabilities and/or preferences associated with primary connection 206 and secondary connection 204 to determine whether the reply can be delivered to each of the client devices 106a, 106b associated with “User A” 110. At step (2), assuming the IM data can be delivered on both connections 204, 206, messaging service network 102 performs a target broadcast of the IM reply data on connections 204, 206. In other words, “User A” 110 client device 106a and client device 106b each receive the same IM data reply message. At step (3), after performing checks on preferences and/or capabilities associated with secondary connection 210, messaging service network 102 performs a sender broadcast of a copy of the IM reply data on secondary connection 210 to each “User B” 110 client device 108a where “User B” 112 is not currently active.

In FIG. 3, a method for processing a “close window” command is shown for purposes of illustration. In one embodiment of the present invention, the close window command message can be used by a user to perform a clean-up of corresponding user interface windows (e.g. instant messaging display windows) on each instance of a client device associated with a user, including client device 106a where the user is currently active and each of the other client devices where the user is not currently active. For example, at step (1) client device 106a sends a close window command message to messaging service network 102 on primary connection 204 in response to “User A” 110, who is currently active at client device 106a, closing a user interface window at active client device 106a. Before delivery of the close window command data to client device 106b, messaging service network 102 checks the capabilities and/or preferences associated with secondary connection 206 to determine whether the close window command data can be delivered to client device 106b. At step (2), assuming the close window data can be delivered on secondary connection 206, messaging service network 102 performs a sender broadcast of the close window message data on secondary connection 206. In response to receiving the close window message data, client device 106b closes the window corresponding to the window that was close by “User A” on active client device 106a. In this manner, if “User A” later transitions to client device 106b, the look and feel of the user interface displayed on client device 106b will match the user interface displayed on client device 106a.

In FIG. 4A, a method for processing an “add buddy” command is shown for purposes of illustration. In one embodiment of the present invention, the add buddy command message can be used by an originating user to request adding a target user to the originating user's buddy list. As discussed above, a buddy list is a list of frequent contacts typically used in connection with an instant messaging (IM) program. For example, at step (1) client device 106a, where User A 110 is currently active, sends an add buddy command message to messaging service network 102 on primary connection 204, requesting to add User B 112 to User A's 110 buddy list. At step (2), because the messaging service network 102 needs to verify that User B 112 is a valid user id, the messaging service network 102 replies to User A's 110 request by sending a reply broadcast of an “add pending” message to the originating client device 106a where User A 110 is currently active and to all other instances of client devices 106b associated with User A 110, respectively on primary connection 204 and secondary connection(s) 206. The add pending message notifies all instances of client devices 106a, 106b associated with User A 110 that an add buddy request is pending with another user. At step (3), messaging service network 102 then sends a target broadcast of an “add authorize” message to all instances of client devices 108a, 108b associated with User B 110 so that any one instance of a client device 108a, 108b can reply to the add buddy request with an approval or denial.

In FIG. 4B, a method for sending an “authorize buddy add” command is shown for purposes of illustration. In one embodiment of the present invention, the authorize buddy add command message can be used by a target user to authorize its addition to an originating user's buddy list. For example, at step (1) client device 108b, where User B 112 is currently active, sends an authorize buddy add command message to messaging service network 102 on primary connection 208, in response to User A's 110 request to add User B 112 to User A's 110 buddy list as shown in FIG. 4A. At step (2), in response to receiving the authorize buddy add message, messaging service network 102 sends a target broadcast of the authorize buddy add message to all instances of client devices 106a, 106b associated with User A 110. The authorize buddy add message notifies all instances of client devices 106a, 106b associated with User A 110 that an add buddy request has been authorized by User B 112. At step (3), messaging service network 102 also sends a sender broadcast of a copy of the authorize buddy add message to all instances of client devices 108a associated with User B 112 where User B 112 is not currently active. Sending a copy of the authorize buddy add message to all instances of client devices 108a where User B 112 is not currently active notifies the client devices 108a that they can close their respective authorization prompt windows because the authorization has been granted.

In FIG. 4C, a method for processing an “add buddy failure” command is shown for purposes of illustration. In one embodiment of the present invention, and add buddy failure occurs when an originating user wants to add a target user to its buddy list, and the target user does not exist or the target user does not grant the authorization to be added. In this case, the messaging service network 102 can send a simple reply message only to the client device 106a where the originating user is currently active. The simple message notifies the originating user that the add buddy request has failed. For example, at step (1) client device 106a, where User A 110 is currently active, sends an add buddy command message to messaging service network 102 on primary connection 204, requesting to add User B 112 to User A's 110 buddy list. At step (2), in response to receiving the authorize buddy add message, messaging service network 102 sends a simple reply message only to the client device 106a where User A 110 is currently active notifying User A 110 that the add buddy request has failed. The simple reply message is sent on primary connection 204.

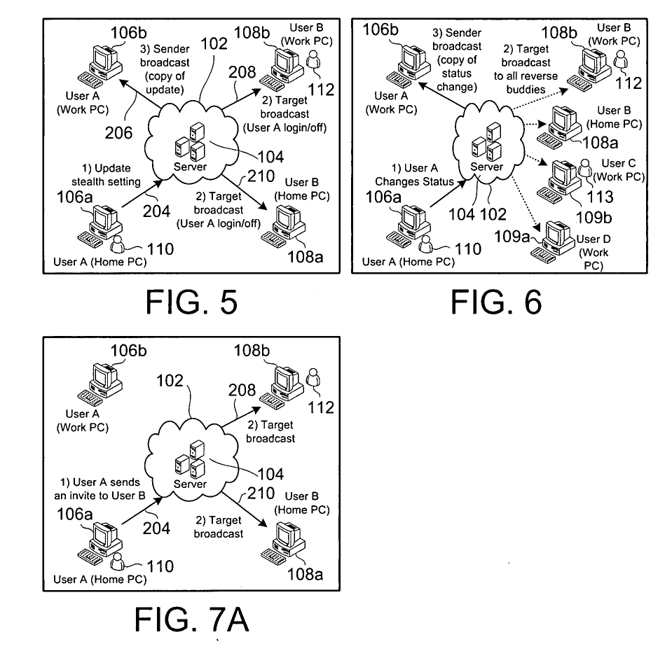

In FIG. 5, a method for processing an “update stealth setting” command is shown for purposes of illustration. In one embodiment of the present invention, the update stealth setting command can be used when a user wants remain online but appear “invisible” to one or more other users. In one embodiment of the present invention, the update stealth setting command can be set to notify a target user that an originating user is either “logging in” or “logging off.” For example at step (1) if User A 110 wants to appear invisible to User B 112, User A 110 can update its stealth setting by sending an update stealth setting command to the messaging service network 102 with “logging off” set. At step (2), in response to receiving the update stealth command, messaging service network 102 can perform a target broadcast of a message to all instances of client devices 108a, 108b associated with User B 112 that notifies each client device 108a, 108b that User A 110 is either logging in or logging off. At step (3), messaging service network 102 can also perform a sender broadcast of a copy of the update stealth setting command to all instances of client devices 106b where User A 110 is not currently active.

In FIG. 6, a method for processing a “status change” command is shown for purposes of illustration. In one embodiment of the present invention, the status change command can be used when an originating user wishes to notify user(s) on the originating user's reverse buddy list or watcher list (i.e., users who have subscribed for the presence of the originating user) of the originating user's presence status. As discussed above, a user's presence status can include information about whether the user is “available,” “busy,” “idle,” “logged in,” or “logged off,” etc. For example, at step (1) when User A 110 wants to update its presence status with User B 112 and User C 113, User A 110 can send a status change command to the messaging service network 102 that identifies User B 112 and User C 113 as recipients and includes User A's 110 current presence status. In one embodiment, the recipients often are identified by service network 102, and not provided by user A directly. At step (2), in response to receiving the status change command sent from User A 110, messaging service network 102 can perform a target broadcast of the status change to all instances of client devices 108a, 108b associated with User B 112 and all instances of client devices 109a, 109b associated with User C 113. At step (3), messaging service network 102 can also perform a sender broadcast of a copy of the status change to all instances of client devices 106b where User A 110 is not currently active so that client devices 106b also reflect the presence status change.

In FIG. 7A, a method for processing an “invite” command is shown for purposes of illustration. As discussed above, the invite command is a session-based command that can be used for data transmissions that require a persistent session, for example photo sharing, file transfers, web cam communication, etc. In particular, the invite command can be used by an originating user to invite a target user to establish a session with the originating user for communicating data that requires a persistent session. For example, at step (1) User A 110 sends an invite command to User B 112 via messaging service network 102. At step (2), upon receiving the invite command, messaging service network 102 can perform a target broadcast of the invite to all instances of client devices 108a, 108b associated with User B 112. In one embodiment, messaging service network 102 sends the invite to all instances of client devices 108a, 108b because at the time User A 110 sends the invite to User B 112, User A 110 does not know which of the client devices 108a, 108b associated with User B 112 is the client device where User B 112 will access next.

In FIG. 7B, a method for processing an “accept invite” command is shown for purposes of illustration. In one embodiment, the accept invite command can be used by a target user to accept an invitation (see FIG. 7A) to establish a data communication session with an originating user. For example, at step (1) as soon as User B 112 receives the invite from messaging service network 102 at client device 108b, User B 112 responds by sending a message on primary connection 208 to messaging service network 102 accepting the invite sent by User A 110 in FIG. 7A. In one embodiment of the present invention, the invite can only be accepted at the client device 108b where User B 112 is currently active (e.g. physically located). At step (2), upon receiving the acceptance message from User B 112 on primary connection 208, messaging service network 102 can forward the acceptance message to User A 110 on originating connection 204 only at the client device 106a where User A 110 is currently active, according to one embodiment. In one embodiment of the present invention, messaging service network 102 sends User B's 112 acceptance message only to client device 106a where User A 110 is currently active and not to the other instances of client devices 106b associated with User A 110. This is done because after an acceptance is sent by User B 112 at client device 108b and received by User A 110 at client device 106a, all further communication between User A 110 and User B 112 will be carried out using an end point-to-end point persistent session established between the client devices 106a and 108b where User A 110 and User B 112 are currently active, as illustrated in FIG. 7C. At step (3), according to one embodiment of the present invention, messaging service network 102 can also perform a sender broadcast of a copy of the acceptance message to all instances of client devices 108a where User B 112 is not currently active. Step (3) can be performed to insure that all instances of client devices 108a associated with User B are consistently maintained and proper cleanup performed. For example, the invite window on each of User B's client devices can be closed.

In FIG. 7C, a system and method for providing session-based real time data communication between users is shown for purposes of illustration. In one embodiment of the present invention, as shown in FIG. 7C, persistent sessions 702, 704 are established between the primary instances of User A 110 and User B 112 via messaging service network 102 to facilitate the sending/receiving of session-based data (e.g. photo sharing data, file transfer data, web cam data) between User A 110 and User B 112.

According to a further embodiment of the present invention, a “voice” connection is a special type of connection established by client devices capable of sending/receiving voice data, for example SIP (Session Initiation Protocol) phones or any other client device capable of sending/receiving voice data. According to one embodiment of the present invention, depending on the capabilities of the client device, a voice connection associated with a client device may or may not have instant messaging (IM) functionality preferences and/or capabilities. Similarly, a connection associated with a client device may or may not be capable of displaying buddy list information and/or receiving and processing buddy list status information. Any SIP phone could have the ability to display and use the buddy list information, but it is not required. SIP phones don't have to able to send IMs either. Thus, the client capabilities may differ, such as when the client does not have a proper display device to display the buddy list or keypad to send IM.

In one embodiment, presence status information may not be associated with a voice connection if the client device that established the voice connection with the messaging service network is always online.

In FIG. 8, a system and method for providing voice data communication between users is provided for purposes of illustration. At step (1) if User A 110 wants to call up (i.e. ring) User B 112, User A 110 sends a “SIP invite” command message to messaging service network 102. At step (2), upon receipt of the SIP invite message, messaging network 102 sends the SIP invite message to all instances of client devices 108a, 108b associated with User B 112. By sending the SIP invite message to all instances of client devices 108a, 108b associated with User B 112, each instance of client devices 108a, 108b associated with User B 112 will ring. At step (3), upon receipt of the SIP invite message, one instance User B 112 can accept User A's 111 invitation by sending a SIP acceptance message to User A 110 via messaging service network 102. At step (4), messaging service network 102 can send the SIP acceptance message received from the User B 112 instance 108b that accepted the invitation to the client device 106a associated with User A 110 that originated the SIP invite message at step (1). Additionally, in one embodiment, messaging service network 102 can also send the SIP acceptance message received from the User B 112 instance 108b that accepted the invitation to the other User B 112 instances 108a so that the other User B 112 instances 108a can stop ringing. At step (5), a session (or media stream) 802 is established between User A 110 and User B 112 so that User A 110 and User B 112 can talk via the media stream 802.

In FIG. 9, according to a further embodiment of the present invention, alert data (e.g. weather alerts, news alerts, or any other type of alert) or any other suitable data can be broadcast by messaging service network 102 to all instances of a particular user. For example, as shown in FIG. 9 for purposes of illustration, at step (1) alert data can be sent to messaging service network 102 from any service resource 902 (e.g. Yahoo! News Weather, etc.) capable of providing alert data (or any other type of data) to the messaging service network 102. At step (2), in response to receiving the alert data from service resource 902, messaging service network 102 can send a target broadcast of the alert data to all instances of client devices 106a, 106b associated with User A 110. At step (3), when the alert is acknowledged (i.e. accepted) at the client device 106a where User A 110 is currently active, an acknowledgement message (e.g. “close window” command, etc.) is sent from client device 106a by User A 110 to messaging service network 102. At step (4), upon receipt of the acknowledgement message, messaging service network 102 can send a copy of the acknowledgement message to all other instances of client devices 106b associated with User A 110 so clients devices 106b can close their windows, or perform any command that might be associated with the acknowledgement message sent by User A 110 at step (3).

In view of the discussion above, an advantage of embodiments of the present invention is the capability to provide a user the ability to login to a messaging service network from multiple clients and devices at the same time. This approach improves the overall user experience by allowing a user the ability to access the services provided by a messaging service network from several locations with a seamless transition from one client device to another client device.

Although “software” of the present invention may be presented as a single entity, such software is readily able to be executed on multiple machines. That is, there may be multiple instances of a given software program executing on a single machine, or a single program may be executing on different physical machines, etc. Further, two different programs, such as a client and a server program, can be executing in a single machine, or in different machines. A single program can be operating as a client for information transaction and as a server for a different information transaction.

A “computer system” for purposes of embodiments of the present invention may include a single computer, a local area network (LAN), a wide area network (WAN), and the like. A “computer” for purposes of embodiments of the present invention may include any processor-containing device, such as a mainframe computer, personal computer, laptop, notebook, microcomputer, server, personal digital assistant or “PDA,” personal data manager or “PIM” (also referred to as a personal information manager or “PIM”) smart cellular or other phone, so-called smart card, set-top box, or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” or “computer-readable media” for purposes of embodiments of the present invention may be any medium/media that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, carrier wave, or computer memory. The computer readable medium may have suitable instructions for synchronously presenting multiple video program ID streams, such as on a display screen, or for providing for input or presenting in accordance with various embodiments of the present invention.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claim.

What is claimed is:

1. A system for providing multiple points of presence in real time communications, comprising:
a messaging service network, the messaging service network including a server, the server managing real time delivery of data between a first user and a second user; and
two or more client devices associated with the first user, wherein each of the two or more client devices is programmed to establish a connection to the server,
wherein to allow the first user a capability to transition among each of the two or more client devices without interruption, the server is configured to simultaneously maintain each connection and selectively deliver the data to the two or more client devices via the connections based on a type of the data and a capability of each of the two or more client devices.

2. The system as recited in claim 1, wherein the data is one of an instant message, an add buddy message, an update stealth setting message, a status change message, an invite message.

3. The system as recited in claim 1, wherein each of the two or more client devices is one of a mobile device, a laptop computing device, a desktop computing device, a personal data assistant (PDA), a notebook, a microcomputer, a server, a personal data manager, a web-based client, a mobile device, a smart mobile device, IP phone, and an IPhone.

4. The system as recited in claim 1, wherein a connection mode is associated with each connection established the two or more client devices.

5. The system as recited in claim 4, wherein the connection mode is one of a primary connection and a secondary connection.

6. The system as recited in claim 5,
wherein the primary connection is established by only one of the two or more client devices, the only one of the two or more client devices being located where the first user is currently active or where the first user was last known active, and
wherein the secondary connection is established by each of the two or more client devices located where the first user is not currently active or where the first user was not last known active.

7. The system as recited in claim 5, wherein the primary connection is utilized to control a presence status of the first user, the presence status including one of available, busy, idle, logged in, logged off, offline, or online.

8. The system as recited in claim 7,
wherein the presence status of the primary connection of the first user is replicated to each secondary connection established by the client devices located where the first user is not currently active or where the first user was not last known active, and
wherein the presence status of the primary connection of the first user is propagated to all users included on a reverse buddy list or watch list associated with the first user.

9. The system as recited in claim 5, wherein a capability and a preference is associated with the primary connection and each secondary connection.

10. The system as recited in claim 9,
wherein the capability associated with the primary connection identifies at least one feature that a client device is capable of supporting, and wherein the preference associated with the primary connection identifies at least one user preference for receiving a specific type of the data.

11. The system as recited in claim 9,
wherein the capability associated with each secondary connection identifies at least one feature each of the two or more client devices located where the first user is not currently active or where the first user was not last known active is capable of supporting, and
wherein the preference associated with each secondary connection identifies at least one user preference for receiving a specific type of the data at each of the two or more client devices located where the first user is not currently active or where the first user was not last known active is capable of supporting.

12. The system as recited in claim 5, wherein the secondary connection is a status only connection, the status only connection only being capable of receiving the data if the data is status change data.

13. The system as recited in claim 1, wherein each of the two or more client devices hosts a client application, and wherein one or more of the connections established by the two or more client devices is a restricted connection, the restricted connection only being capable of receiving the data from a restricted list of users.

14. The system as recited in claim 1, wherein the real time delivery of the data between the first user and the second user includes delivering the data according to a routing mode, the routing mode being one or more of a target broadcast, a sender broadcast, a complete broadcast, a reply broadcast, and a simple reply.

15. The system as recited in claim 14,
wherein if the routing mode is a target broadcast, an originating client device of the two or more client devices associated with the first user sends the data to the second user via the server, wherein the server sends the data to each of one or more client devices associated with the second user,
wherein if the routing mode is a sender broadcast, the server sends a copy of the data sent from the originating client device of the first user, to each of two or more client devices associated with the first user except for the originating client device;
wherein if the routing mode is a reply broadcast, the server sends the copy of the data sent from the originating client device of the first user, to each of the two or more client devices associated with the first user, only upon a success; and
wherein if the routing mode is a simple reply, the server sends a copy of the data sent from the originating client device of the first user, to the client device associated with the first user where the session is initiated.

16. The system as recited in claim 1, further comprising a service resource coupled to the messaging service network, the service resource being capable of providing alert data to the messaging service network, wherein the messaging service network is capable of delivering the alert data to each of the two or more client devices associated with the first user.

17. The system as recited in claim 16, wherein the alert data is one of weather alerts and news alerts.

18. A system for providing multiple points of presence in real time communications, comprising:
a messaging service network, the messaging service network including a server, the server managing real time delivery of data between a first user and a second user,
wherein the data is utilized to establish a session between the first user and the second user;
a client device associated with the first user, wherein the client device associated with the first user is programmed to establish a first connection to the server, and wherein the client device associated with the first user is a location where the first user is currently active; and
two or more client devices associated with the second user, wherein each of the two or more client devices is programmed to establish a second connection to the server, wherein one of the two or more client devices associated with the second user is a location where the second user is currently active,
wherein to allow the second user a capability to transition among each of the two or more client devices without interruption, the server is configured to simultaneously maintain each second connection and selectively deliver the data to the two or more client devices via the second connections based on a type of the data and a capability of each of the two or more client devices, and
wherein the session is utilized to provide the real time delivery of session-based data between the client device associated with the first user and the one of the two or more client devices associated with the second user.

19. The system as provided in claim 18, wherein the data includes an invite message and an accept invite message for session-based communications.

20. The system as provided in claim 18, wherein the session-based data is photo data, file data, web cam data.

21. A system for providing multiple points of presence in real time communications, comprising:
a messaging service network, the messaging service network including a server, the server managing real time delivery of data between a first user and a second user, wherein the data is utilized to establish a media stream between the first user and the second user;
a client device associated with the first user, wherein the client device associated with the first user is programmed to establish a first connection to the server, and wherein the client device associated with the first user is a location where the first user is currently active; and
two or more client devices associated with the second user, wherein each of the two or more client devices is programmed to establish a second connection to the server, wherein one of the two or more client devices associated with the second user is a location where the second user is currently active,
wherein to allow the second user a capability to transition among each of the two or more client devices without interruption, the server is configured to simultaneously maintain each second connection and selectively deliver the data to the two or more client devices via the second connections based on a type of the data and a capability of each of the two or more client devices, and
wherein the media stream is utilized to provide the real time delivery of voice data between the client device associated with the first user and the one of the two or more client devices associated with the second user.
